(19) United States
(12) Patent Application Publication
(10) Pub. No.: US 2007/0188751 A1
(43) Pub. Date: Aug. 16, 2007

(54) Method for leveling response characteristic of spectroscope

(76) Inventors: Sumio Kawano, Ibaraki (JP); Sirinnapa Saranwong, Ibaraki (JP)

Correspondence Address: CARRIER BLACKMAN AND ASSOCIATES, 24101 NOVI ROAD, SUITE 100, NOVI, MI, 48375, US

(21) Appl. No.: 10/591,305

(22) PCT Filed: Mar. 2, 2005
(86) PCT No.: PCT/JP05/03517

§ 371 Date: Sep. 1, 2006

(30) Foreign Application Priority Data
Mar. 3, 2004 (JP) 2004-058443

(51) Int. Cl. G01J 3/42

(52) U.S. Cl. 356/319

(57) ABSTRACT

A method for standardizing system response of spectrophotometer which corrects the difference between spectrophotometric system responses generated due to the difference in response characteristics of a light source, wavelength selector, and sensor, and involves obtaining the difference spectrum between a master unit and a slave unit relative to a standard material and standardizing the response characteristic of the slave unit to the response characteristic of the master unit by subtracting the difference spectrum from the spectrum of each sample to be measured by the slave unit. With an instrument which is constituted of a light source, wavelength selector, and sensor and to which a NIR spectroscopy is applied, a shift of an absorbance value at each wavelength of the slave unit from the absorbance value of the master unit is similarly generated in each sample to be measured. By subtracting the shift of the absorbance value at each wavelength from the spectrum of each sample, it is possible to correct the spectrum distortion generated due to the difference between system response of spectrophotometer.

### CROSS-REFERENCE TO RELATED APPLICATIONS

The present application is the US National Phase of International Application PCT/JP2005/003517, which in turn claims convention priority from Japanese patent application 2004-058443, filed 3 Mar. 2004. The entire disclosures of the referenced International and Japanese priority documents are incorporated herein by reference.

### TECHNICAL FIELD

The present invention relates to a method for standardizing system response of a spectrophotometer in order to correct the spectrophotometric differences generated due to the difference in response characteristics of a light source, wavelength selector, and sensor.

### Background Art

To control measurement errors and fluctuations generated by a plurality of inspection instruments in large scale production of products, the adjustment to fit each instrument is frequently performed by using an exclusive tool. However, when many check points are present to calibrate the inspection instruments, lots of work times and predetermined man-hours are required and finally, the adjustment cost greatly influences a product price. Therefore, it is preferable to minimize the number of check points to calibrate the instrument. However, in the case of a product for which accuracy of inspection instrument is requested, artifice is necessary.

For example, Patent Document 1 describes the following expression as a relationship between the true signal on an optical disk and the measured signal produced by an optical disk inspection instrument in order to reproduce an optical disk with similar signal using multi-inspection instruments.
True value Yᵢ=Gain correction coefficient aⱼ×measured value Xᵢ+offset correction coefficient bᵢ (a)
Xᵢ: Measured value of reproduced signal
Yᵢ: True value of reproduced signal
aⱼ: Gain correction coefficient for correcting gain for each interval
bⱼ: Offset correction coefficient for correcting offset for each interval

The gain correction coefficient aⱼ and the offset coefficient bⱼ are obtained for each interval. Patent Document 1 describes a method for calibrating each optical disk inspection instrument in accordance with the calibrated values obtained by using expression (a). Furthermore, Patent Document I describes a method for inspecting an optical disk to be inspected using calibrated inspection instruments.

Patent Document 1: Japanese Patent Application Publication No. 2003-1897440

### SUMMARY OF THE INVENTION

However, when an object to be inspected has a frequency (wavelength) response more complex than that of an optical disk, for example, spectrum of an apple measured in a wavelength range of 700 to 1,100 nm by using a dispersive-type near infrared instrument, there is a problem that individual difference between objects to be measured is larger than that presented in an optical disk.

Though the approximate expression (a) shown in Patent Document 1 is used, it is impossible to find a proper linear correction parameter as shown by linear correction data in Table 1.

Also when using the following approximate expression (b) using a more-complex polynomial,
y=k₀+k₁s+k₂x² (b)

it is impossible to find a proper polynomial parameter as shown by the polynomial correction data in Table 1.

TABLE 1

| | Calibration method | | | |
|---|---|---|---|---|
| | MLR | | PLS | |
| Adjustment condition | SEP | Bias | SEP | Bias |
| No adjustment | 0.34 | −0.42 | 0.35 | −0.53 |
| 700-1,100 nm linear correction | 0.34 | −1.07 | 0.32 | −1.31 |
| 700-1,100 nm polynomial correction | 0.34 | −0.48 | 0.31 | −1.14 |
| 850-1,050 nm linear correction | 0.34 | −0.46 | 0.32 | −1.24 |
| 850-1,050 nm polynomial correction | 0.34 | 0.25 | 0.31 | −1.06 |

(Note 1)
Analysis algorithm
MLR (Multiple Linear Regression)
PLS (Partial Least Squares)
(Note 2)
SEP: Residual-error standard error (Bias-corrected standard error of prediction)

Bias: Average of differences between actual values according to chemical analysis and estimated values according to near infrared spectroscopy

Moreover, when moving a calibration model (hereafter referred to as model) for performing quantitative analysis and qualitative analysis by using the near infrared spectroscopy from a unit developing the model to another similar unit, an error occurs due to the difference between spectrophotometric system responses. In the case of the quantitative analysis, there is a method referred to as bias correction method of the model as a correction method. However, this method is to correct an estimated result which requires correction for each model and labor and whose operation is complicated. However, the correction method for qualitative analysis is not developed yet.

It is an object of the present invention to provide a method for standardizing system response of a spectrophotometer for correcting the distortion of a spectrum generated due to the difference between system responses of spectrophotometers so that a model developed by a master unit can be used by a slave unit.

To achieve the above object, a method of the present invention for standardizing the system response of a spectrophotometer involves adjusting the system response of a slave unit to the system response of a master unit by calculating the difference spectrum between the slave unit and the master unit. For example, the difference spectrum may be calculated by subtracting a spectrum of a standard material, for example, a second derivative spectrum, measured by the slave unit from a second derivative spectrum of a standard material measured by the master unit. Then the spectrum of each object measured by the slave unit is standardized by subtracting with the calculated difference spectrum. By using the second derivative spectrum for calculating the difference spectrum, there is an advantage that baseline shift is eliminated.

As the spectrum of the standard material, the spectrum of a sample to be measured, second derivative spectrum, or average spectrum of those spectra mentioned before is considered. In the case of the average spectrum, the following two cases are assumed: a case of measuring a plurality of spectra by one sample to be measured and obtaining the average spectrum and a case of measuring a plurality of spectra by a plurality of samples and obtaining the average spectrum.

An instrument to which near infrared spectroscopy is applied is constituted of a light source, wavelength selector, and sensor. Wavelength characteristics, light intensity, and sensor sensitivities of spectrophotometer are delicately different for each individual instrument and the combination of these responses gives the overall characteristic of the instrument which is delicately different for each instrument. In addition, a shift of the wavelength between each spectrophotometer occurs. However, the spectrophotometric system response is specific to each instrument when a light source, wavelength selector, and sensor are decided.

Therefore, because a shift of absorbance value of a slave unit in each wavelength from a master unit similarly occurs in each sample to be measured, it is possible to correct a spectrum distortion generated due to the difference between spectrophotometric system responses by subtracting the shift of the absorbance value in each wavelength from the spectrum of each sample, for example, second derivative spectrum.

By using the present invention, in the case of a fruit sweetness sorting machine, it is easy to transfer a mathematical model to predict sweetness developed from spectra of a master unit to a plurality of other sweetness sorting units (slave units). By this invention, the difference between lines is eliminated, and the reliability of the sweetness sorting machine is improved. Moreover, there are advantages that the sweetness sorting machine is easily maintained and persons are released from the hard work at the job site for correcting the difference between lines by the conventional bias-correction technique.

### BRIEF DESCRIPTION OF THE DRAWINGS

FIG. 1 is an illustration showing an example of an apple sweetness sorting machine;

FIGS. 2(a) and 2(b) are illustrations showing second derivative spectra measured by near infrared (NIR) instruments A and B;

FIG. 3 is an illustration showing an example of applying a model developed by the NIR instrument A to the spectrum of the NIR instrument B;

FIG. 4 is an illustration showing a difference spectrum obtained by subtracting the second derivative spectrum of an apple measured by the NIR instrument A from that of an apple measured by the NIR instrument B;

FIG. 5 is an illustration showing an example of applying a model developed by the NIR instrument A to the standardized spectra of the NIR instrument B; and

FIG. 6 is an illustration showing a difference spectrum obtained by subtracting the average spectrum of second derivative spectra measured by a master unit from the average spectrum of second derivative spectra measured by a slave unit and the average spectrum of the master unit.

### DETAILED DESCRIPTION OF THE INVENTION

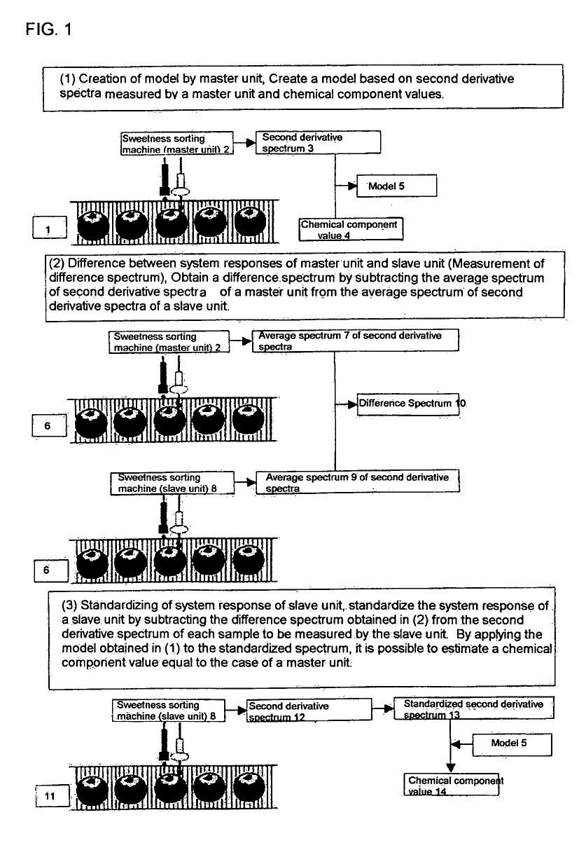

A best mode for carrying out the invention is described below. FIG. 1 is one of the embodiments of the present invention, which shows an example of an apple sweetness sorting machine. In the case of the sweetness sorting machine, a tungsten lamp is used for the light source, a grating is used for the wavelength selector, and a diode array detector is used for the sensor.

At the stage for preparing a model by the master unit in FIG. 1(1), a plurality of samples (apples) 1 to be measured are measured by the sensor 2 of the master unit to obtain the second derivative spectrum 3 of the master unit. Then, chemical component values 4 of the samples (apples) 1 are obtained. A model 5 is obtained by the chemometrics method such as the multiple regression based on the data for the above second derivative spectrum 3 and the above chemical component values 4.

At the stage for obtaining the difference between spectral characteristics of the master unit and slave unit in FIG. 1(2), a plurality of samples (apples) 6 to be measured are measured by the sensor 2 of the master unit to obtain the average spectrum of the second derivative spectra of the master unit. Then, the same samples (apples) 6 to be measured are measured by the sensor 8 of the slave unit to obtain the average spectrum 9 of the second derivative spectra of the slave unit. Moreover, the difference spectrum 10 of second derivative values is obtained by subtracting the average spectrum 7 of the master unit from the average spectrum 9 of the slave unit.

At the stage for standardizing the spectral characteristics of the slave unit in FIG. 1(3), each sample (apple) 11 to be measured is measured by the sensor 8 of the slave unit and the second derivative spectrum 12 of the slave unit is measured to obtain a standardized second derivative spectrum 13 obtained by subtracting the difference spectrum 10 from the second derivative spectrum 12. By applying the model 5 to the standardized second derivative spectrum 13, a purposed chemical component value 14 is obtained.

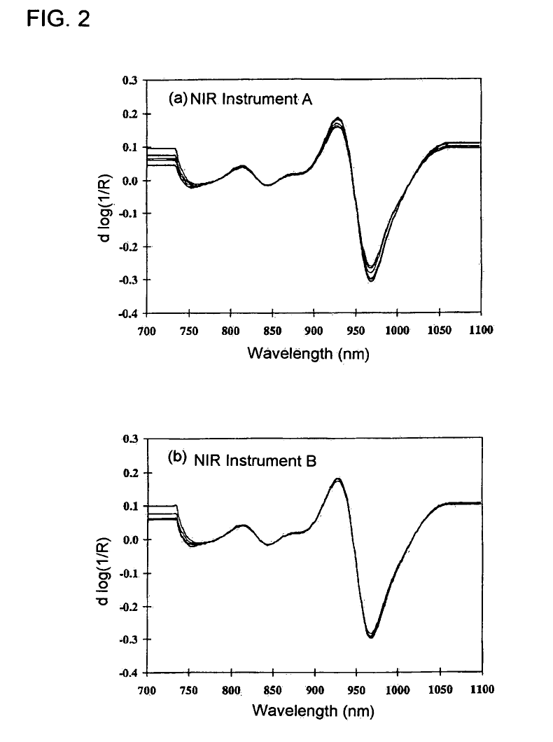

FIG. 2 shows near infrared second derivative spectra of apples (variety: Fuji) measured by two dispersive-type near infrared instruments (NIR Systems, NIRS6500) (referred to as NIR instruments A and B). The near infrared instrument uses a tungsten lamp as a light source, a grating as a wavelength selector, and a silicon detector as a sensor.

The following model is developed by multiple regression based on the second derivative values measured by the NIR instrument A and sugar contents (Brix values) of 100 apples.
C=16.035−266.386D2A(906)+1351.578D2A(870) (1)
Where, C is a Brix value, and D2A(906) and D2A(870) are second derivative values of spectra at 906 nm and 870 nm, respectively.

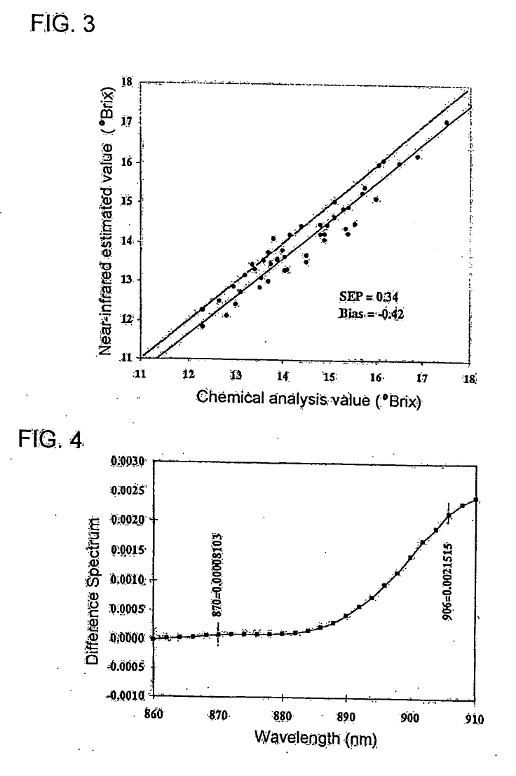

FIG. 3 shows results of applying the model of the above expression (1) to a spectrum measured by the NIR instrument B. In this case, it is found that a negative bias of −0.42° Brix is generated.

FIG. 4 is a difference spectrum obtained by subtracting the average spectrum of second derivative spectra of the above 100 apples measured by the NIR instrument A from the average spectrum of second derivative spectra of the same samples measured by the NIR instrument B. FIG. 4 shows the wavelength range of 860 to 910 nm to be used for the model. It is found that the second derivative value of the NIR instrument B is slightly larger than that of the NIR instrument A in the wavelength region. At 906 nm, the second derivative value is larger by 0.0021515 and at 870 nm, the value is large by 0.0008103. Therefore, when assuming that the second derivative values at 906 nm and 870 nm of the NIR instrument B are D2A(906)_{B}, and D2A(870)_{B}, respectively, a corrected value is obtained from the following expression.
D2A(906)=D2A(906)_{B}−0.0021515
D2A(870)=D2A(870)_{B}−0.0008103 (2)

By substituting the value of expression (2) for the model of expression (1), it is possible to apply the model developed by the NIR instrument A to the spectrum measured by the NIR instrument B.

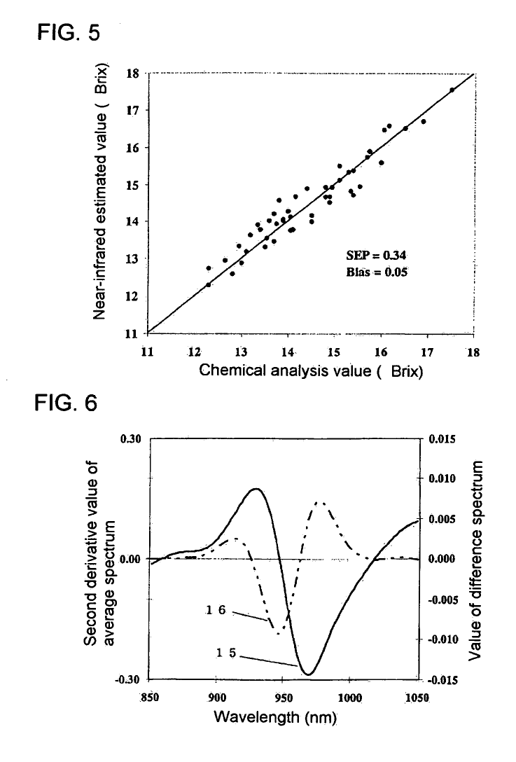

FIG. 5 shows results of correcting and recalculating the data shown in FIG. 3 by the above described method. A bias becomes 0.05° Brix and occurrence of errors produced due to the difference between system responses of spectrophotometers is almost cancelled. This improvement degree is clear as a result of comparing with calibration result data of linear correction and polynomial correction in Table 1.

FIG. 6 shows a difference spectrum obtained by subtracting the average spectrum of second derivative spectra measured by the master unit from the average spectrum of second derivative spectra measured by the slave unit and the average spectrum of the master unit in a wavelength region of 850 to 1,050 nm together. When assuming a difference spectrum as ΔA(λ) and a second derivative spectrum of each sample measured by the slave unit as S_{B}(λ), a standardized second derivative spectrum S_{C}(λ) is shown by the following expression.
S_{C}(λ)=S_{B}(λ)−ΔA(λ) (3)

Where, λ is a wavelength (nm).

### INDUSTRIAL APPLICABILITY

It is possible to apply the method for standardizing system response of spectrophotometer by the present invention to, for example, a sweetness sorting machine which measures the spectrum of fruit moved by a belt conveyer and selects the fruit in accordance with an obtained sugar content.

Although there have been described what are the present exemplary embodiments of the invention, it will be understood that variations and modifications may be made thereto within the spirit and scope of the appended claims.

1. A method for standardizing system response of a spectrophotometer comprising:
a step of obtaining the difference spectrum between a master unit and a slave unit by subtracting the spectrum of a standard material measured by the master unit from the spectrum of the standard material measured by the slave unit serving as another spectrophotometer similar to the master unit; and
a step of making the system response of the slave unit coincide with the system response of the master unit by subtracting the difference spectrum from the spectrum of each sample to be measured by the slave unit.

2. The method for standardizing system response of a spectrophotometer according to claim 1, wherein
the spectrophotometer is set to a sweetness sorting machine.

3. The method for standardizing system response of a spectrophotometer according to claim 1, wherein
the spectrum of the standard material is a spectrum of a sample to be measured, a second derivative spectrum, or an average of these two spectra.

4. The method for standardizing system response of a spectrophotometer according to claim 1, wherein
the spectrum of the standard material is the spectrum or average spectrum of a material similar to a sample to be measured in optical density.
